(19) United States
(12) Patent Application Publication
(10) Pub. No.: US 2012/0286075 A1
(43) Pub. Date: Nov. 15, 2012

(54) Telescoping tripod sprinkler cart

(76) Inventor: David Brueske, Olympia, WA (US)

(21) Appl. No.: 13/068,530

(22) Filed: May 12, 2011

(51) Int. Cl. B05B 3/00

(52) U.S. Cl. 239/722

(57) ABSTRACT

A Telescoping Tripod Sprinkler Cart comprising a tripod junction unit, a plurality of support members, a sprinkler support assembly, and a telescoping assembly. In some preferred embodiments, the Telescoping Tripod Sprinkler Cart may also include a carriage assembly to enable the portability of the Telescoping Tripod Sprinkler Cart.

### FIELD OF THE INVENTION

The present invention is in the area of lawn sprinklers, and more particularly pertains to an apparatus for irrigation.

### BACKGROUND OF THE INVENTION

One of the most common chores for a homeowner to address is watering or irrigating a lawn. While some people may use a simple lawn hose to manually irrigate their lawns, most people use various irrigation systems. These irrigation systems can be used to cover large swaths of landscape quickly and efficiently.

However, the problem with sprinkler systems is their relative high cost and attendant installation. Their relative high cost can stem in large part from the installation thereof. Effective installation requires that underground tunnels or troughs be dug. In many instances, these distances can exceed 50 yards in length. As a consequence, this installation can require a substantial amount of back-breaking work.

Therefore, what is clearly needed in the art is an apparatus which enables someone to irrigate a large lawn, orchard, or garden and cover a large diameter of space.

### SUMMARY OF THE INVENTION

It is an object of the present invention to provide an apparatus to elevate an irrigation sprinkler to increase the surface area to be covered. By manually adjusting the height of the sprinkler head above ground, a person will be enabled to cover wide areas of lawn, landscape, gardens, orchards, or other areas where constant irrigation is required.

It is an object of the present invention to provide a portable apparatus with pneumatic wheels to place an elevated tripod sprinkler cart in its desired destination. Oftentimes, long hoses can become heavy, and with the wheels, the towing thereof can be made substantially easier.

### BRIEF DESCRIPTION OF THE DRAWING FIGURES

FIG. 1 is a perspective view of a preferred embodiment of the present invention.

FIG. 2 is a perspective view of a preferred embodiment of the present invention.

FIG. 3 is a perspective view of a preferred embodiment of the present invention.

FIG. 4 is a perspective view of a preferred embodiment of the present invention.

FIG. 5 is a plan view of a preferred embodiment of the present invention.

FIG. 6 is a perspective view of a preferred embodiment of the present invention.

FIG. 7 is a rear elevation view of a preferred embodiment of the present invention.

FIG. 8 is a perspective view of a preferred embodiment of the present invention.

FIG. 9 is a perspective view of a preferred embodiment of the present invention.

FIG. 10 is a plan view of a preferred embodiment of the present invention.

FIG. 11 is a plan view of a preferred embodiment of the present invention.

### DESCRIPTION OF PREFERRED EMBODIMENTS

According to a preferred embodiment of the present invention, a unique Telescoping Tripod Sprinkler Cart is used to help elevate an irrigation sprinkler head to maximize irrigation coverage. The present invention is described in enabling detail below.

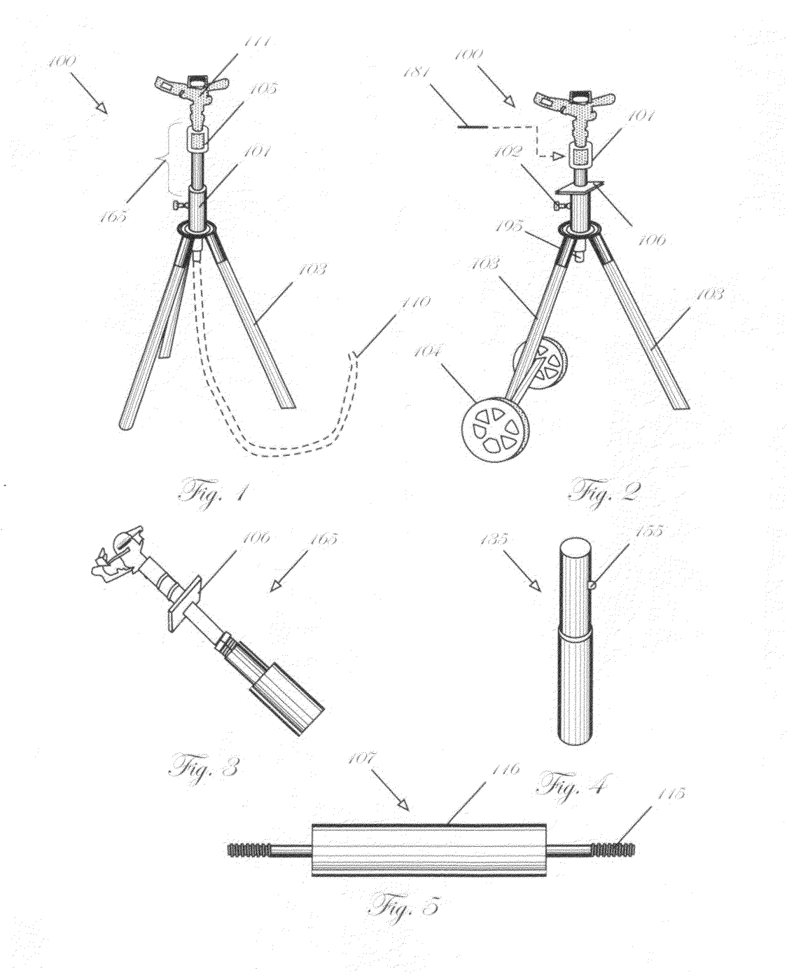

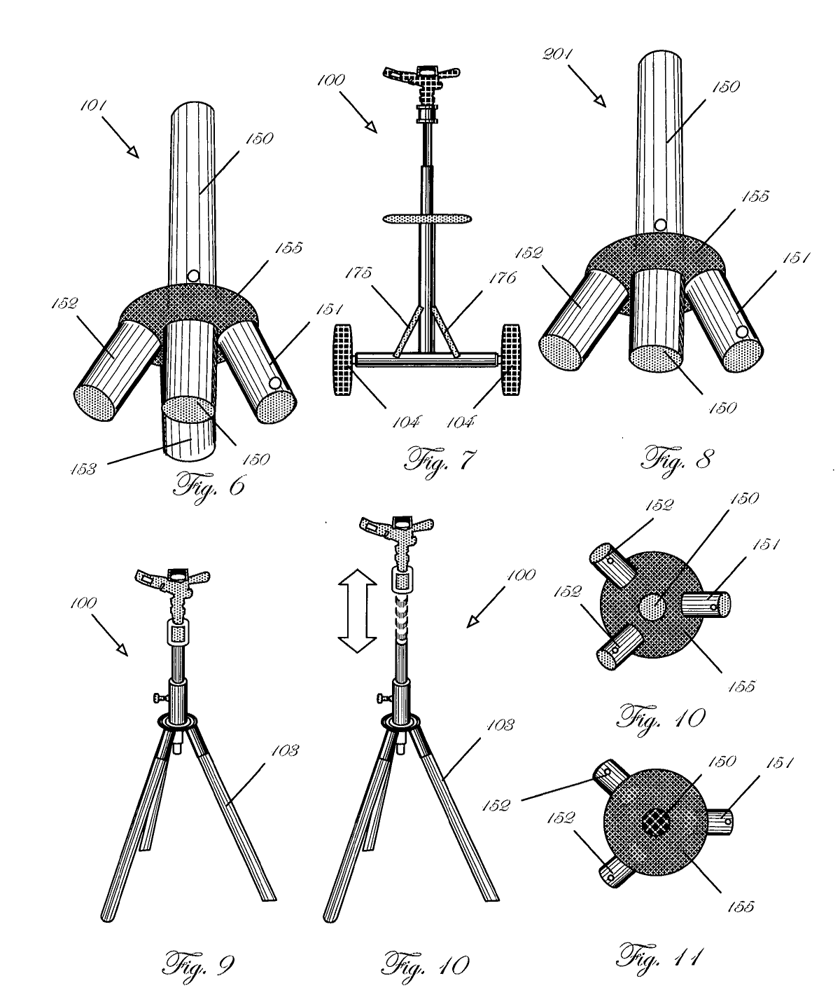

FIGS. 1-5 illustrate that a Telescoping Tripod Sprinkler Cart 100 includes a tripod junction unit 101, a plurality of support members 103, a sprinkler support assembly 165, and a telescoping assembly 135. In some preferred embodiments, the Telescoping Tripod Sprinkler Cart 100 may also include a carriage assembly 107 to enable the portability of the Telescoping Tripod Sprinkler Cart 100.

FIG. 6 illustrates that the tripod junction unit 101 comprises a plate 155, a first leg 151, a second leg 152, a third leg 153, and a hose conduit 150. FIG. 8 illustrates that with the portable Telescoping Tripod Sprinkler Cart embodiment, the tripod junction unit 201 may only comprise two legs. In the portable embodiment, one support member is affixed to the carriage assembly, whereas the other support member supports the weight as it rests on the ground. The hose 110 to which the Telescoping Tripod Sprinkler Cart 100 is attached is attached to the inlet orifice outlet 195. In some preferred embodiments, the Telescoping Tripod Sprinkler Cart 100 may include a knob assembly 102 for adjusting the height of the sprinkler support assembly 165.

FIGS. 1-3 illustrate that the support members are sized to mate with the legs of the tripod junction unit 101. The legs comprise a detent orifice sized to mate with a detent 155 on a support member. The support members comprise a detent for the purpose of fastening the support member to the tripod junction. In some preferred embodiments, the support members may be fastened by complementary male and female threading onto the distal ends thereof. In other embodiments, the affixation can take place through a secure interference fit between the units. And in others, the affixation can be accomplished through a corresponding orifice, and a steel member disposed therethrough.

FIGS. 1-3 also illustrate that in some preferred embodiments, the sprinkler support assembly 165 is disposed upon the hose conduit of the tripod junction. The sprinkler support assembly is telescopic as illustrated in FIGS. 8-9. This telescoping feature can be made possible through a series of detents in some preferred embodiments. FIG. 2 also illustrates that in some preferred embodiments, the sprinkler support assembly may further comprise a top plate 106.

In other preferred embodiments, the Telescoping Tripod Sprinkler Cart 100 may further comprise a fastening assembly 102 for the purpose of modulating the height of the sprinkler support assembly. The fastening assembly, in some preferred embodiments is simply a knob, and a screw which exerts pressure upon the sprinkler support assembly as it is housed within the tripod junction unit.

FIG. 4 illustrates the support member 103. The support member 103 is telescopic with one cylinder disposed within a larger cylinder. A detent 155 is included to mate with a corresponding orifice on the tripod junction unit.

The Telescoping Tripod Sprinkler Cart may also be made to be portable by further incorporating a carriage assembly 107. The carriage assembly includes an axle 115, an axle housing 116, a pair of wheels 104, and a pair of struts 175, 176. When the Telescoping Tripod Sprinkler Cart is in a 45° position, most or all of the weight is transferred to the wheels. In some preferred embodiments, the wheels are pneumatic.

FIG. 1 illustrates that the Telescoping Tripod Sprinkler Cart 100 may include a sprinkler head 111. The sprinkler head may be set for full or part circle pattern.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Telescoping Tripod Sprinkler Cart comprising a tripod junction unit, a plurality of support members, a sprinkler support assembly, and a telescoping assembly;
the tripod junction unit comprises a first leg, and a second leg, and a hose conduit;
the plurality of support members are sized to mate with the legs;
the legs comprise a detent orifice sized to mate with a detent on a support member;
the support members comprise a detent for the purpose of fastening the support member to the tripod junction;
the sprinkler support assembly is disposed upon the hose conduit of the tripod junction.

2. The Telescoping Tripod Sprinkler Cart of claim 1 further comprising a carriage assembly; the carriage assembly comprises an axle, an axle housing, a pair of wheels, and a pair of struts.
